(19) United States
(12) Patent Application Publication
(10) Pub. No.: US 2025/0187570 A1
(43) Pub. Date: Jun. 12, 2025

(54) EMERGENCY BRAKING APPARATUS AND EMERGENCY BRAKING METHOD

(71) Applicants: Hyundai Motor Company, Seoul (KR); Kia Corporation, Seoul (KR)

(72) Inventor: Sang Bum KOH, Suwon-si (KR)

(73) Assignees: Hyundai Motor Company, Seoul (KR); Kia Corporation, Seoul (KR)

(21) Appl. No.: 18/592,862

(22) Filed: Mar. 1, 2024

(30) Foreign Application Priority Data
Dec. 8, 2023 (KR) 10-2023-0177200

(51) Int. Cl. B60T 8/171; B60K 35/28; B60T 8/172

(52) U.S. Cl. CPC B60T 8/171; B60K 35/28; B60T 8/172; B60K 2360/16; B60T 2220/04; B60T 2240/00; B60T 2270/402; B60T 2270/404; B60T 2270/82

(57) ABSTRACT

An emergency braking apparatus, may include: a first controller controlling a braking device; a pedal stroke sensor receiving pedal stroke information of a brake pedal; and a second controller connected to the first controller by a wire to control the first controller, based on the pedal stroke information, wherein the first controller may be wirelessly connected to the pedal stroke sensor and receive the pedal stroke information to control the braking device.

### CROSS-REFERENCE TO RELATED APPLICATION(S)

The present application claims priority to Korean Patent Application No. 10-2023-0177200 filed on Dec. 8, 2023, the entire contents of which is incorporated herein for all purposes by this reference.

### BACKGROUND OF THE PRESENT DISCLOSURE

### Field of the Present Disclosure

The present disclosure relates to an emergency braking apparatus and an emergency braking method.

### DESCRIPTION OF RELATED ART

A braking device is a device for reducing speed of a running vehicle or stopping the vehicle, so that the braking device may be said to be the most important device in vehicle safety. A vehicle's braking device is a device for converting rotational energy of tire wheels into thermal energy using frictional force to reduce vehicle speed and stop the vehicle.

A braking device applied to a vehicle includes a hydraulic braking device and an electromechanical braking (EMB) device. The hydraulic braking device is a device for mechanically generating braking force using hydraulic pressure. The electromechanical braking (EMB) device is a braking device for generating braking force using an electric actuator instead of hydraulic pressure.

Compared to the hydraulic braking device, the electromechanical braking (EMB) device is eco-friendly and has excellent braking response and control performance, so that the number of vehicles to which the electromechanical braking (EMB) device is applied is increasing.

Meanwhile, in the electromechanical braking (EMB) device, a main controller provided in a vehicle body and a local controller provided in each individual electromechanical braking (EMB) device are connected to each other by wire, the local controller receives a braking control command from the main controller using a wired communication, and controls an electric actuator provided in the electromechanical braking (EMB) device to generate braking force.

Accordingly, when a problem has occurred in the wired connection between the main controller and the local controller, or when a problem has occurred in the main controller itself, the local controller may not receive the braking control command and may not generate braking force normally, such that there may be a risk of an accident.

According to the related art, braking of the electromechanical braking (EMB) device is performed using an electromechanical braking (EMB) device that can receive a normal control signal, but there is a risk that a problem such as unstable vehicle posture, insufficient braking force, and the like may occur due to an inoperable electromechanical braking (EMB) device.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an emergency braking apparatus and an emergency braking method that can stably generate braking force even when a problem has occurred in a wired connection.

According to an aspect of the present disclosure, an emergency braking apparatus, may include: a first controller configured for controlling a braking device; a pedal stroke sensor receiving pedal stroke information of a brake pedal; and a second controller connected to the first controller by a wire to control the first controller, based on the pedal stroke information, wherein the first controller may be wirelessly connected to the pedal stroke sensor and receive the pedal stroke information to control the braking device.

The first controller and the second controller may be dually connected by a first wire and a second wire, and the second controller may be configured for controlling the first controller using either the first wire or the second wire.

When an error has occurred in at least one of the first wire and the second wire, the first controller may be wirelessly connected to the pedal stroke sensor and receive the pedal stroke information.

The first controller is configured to receive the pedal stroke information using Bluetooth.

The first controller is configured to receive the pedal stroke information using a tire pressure monitoring system (TPMS) provided with a low frequency initiator (LFI).

The first controller may further include a display unit displaying that the pedal stroke information has been received using a tire pressure monitoring system.

The first controller is configured to receive the pedal stroke information modulated from the tire pressure monitoring system by a radio frequency (RF) signal.

The first controller may be configured for controlling a braking device by decoding the pedal stroke information.

A radio frequency for transmitting the pedal stroke information may be set differently from a radio frequency for transmitting wake up information of the tire pressure monitoring system.

The first controller may be configured for controlling a braking device to generate braking force in proportion to a size of the pedal stroke.

According to an aspect of the present disclosure, an emergency braking method, may include: an operation in which a first controller is configured to receive braking information from a second controller connected to the first controller by wire; and an operation of controlling a braking device based on the braking information, wherein when an error has occurred in a wired connection, the operation in which the first controller is configured to receive braking information from a second controller connected to the first controller by a wire may include an operation in which the first controller is configured to receive pedal stroke information using a wireless connection, and an operation of controlling a braking device using a first controller, based on one of the pedal stroke information or the driving information.

The first controller and the second controller may be dually connected by a first wire and a second wire, and in an operation of confirming braking information of the second controller connected to the first controller by wire, the first controller may confirm the braking information of the second controller using one of the first wire and the second wire.

When an error has occurred in one of the first wire and the second wire, in the operation of controlling a braking device using a first controller, the braking device may be controlled based on the braking information.

When an error has occurred in one of the first wire and the second wire, in the operation of controlling a braking device using a first controller, the braking device may be controlled based on the pedal stroke information.

In the operation in which the first controller receives pedal stroke information using a wireless connection, the pedal stroke information may be received using Bluetooth.

In the operation in which the first controller receives pedal stroke information using a wireless connection, the pedal stroke information may be received using a tire pressure monitoring system (TPMS) provided with a low frequency initiator (LFI).

The operation in which the first controller receives pedal stroke information using a wireless connection may further include receiving the pedal stroke information modulated and transmitted by a pedal stroke sensor, and demodulating the received pedal stroke information.

When receiving the pedal stroke information using the tire pressure monitoring system (TPMS), displaying that tire pressure monitoring information cannot be received may be further included.

In the operation of controlling a braking device using a first controller, the braking device may be controlled to generate braking force in proportion to a size of the pedal stroke.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF DRAWINGS

FIG. 1 is a conceptual diagram of an emergency braking apparatus according to an exemplary embodiment of the present disclosure.

FIG. 2 is a conceptual diagram of an emergency braking apparatus according to another exemplary embodiment of the present disclosure.

FIG. 3 is a flowchart of an emergency braking method according to an exemplary embodiment of the present disclosure.

FIG. 4 is a detailed flowchart of S1000 according to an exemplary embodiment of the present disclosure.

FIG. 5 is a detailed flowchart of S1300 according to an exemplary embodiment of the present disclosure.

FIG. 6 is a flowchart of an emergency braking method according to another exemplary embodiment of the present disclosure.

FIG. 7 is a detailed flowchart of S1400 according to another exemplary embodiment of the present disclosure.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, the present disclosure will be described in detail with reference to the accompanying drawings. In adding reference numerals to elements of each of the drawings, although the same elements are illustrated in other drawings, like reference numerals may refer to like elements. Because the present disclosure can make various changes and have various exemplary embodiments of the present disclosure, specific embodiments are illustrated in the drawings and described in detail. However, this is not intended to limit the present disclosure to specific embodiments, and should be understood to include all modifications, equivalents, and substitutes included in the spirit and scope of the present disclosure.

Terms such as “first,” ““second,” and the like, may be used to describe various components, but the components should not be limited by the terms. These terms are only used for distinguishing one component from another component. For example, a first element may be termed a second element, and similarly, a second element may be termed a first element, without departing from the scope of the present disclosure. The term ‘and/or’ includes a combination of a plurality of related recited items or any one of a plurality of related recited items.

Terms used in the present application are only used to describe specific embodiments, and are not intended to limit the present disclosure. Singular expressions include plural expressions unless the context thereof is clearly dictated otherwise. In the present application, terms such as “comprise” or “having” are intended to designate that there is a feature, number, step, operation, component, part, or combination thereof described in the specification, but one or more other features It should be understood that it does not preclude the possibility of the presence or addition of numbers, steps, operations, components, parts, or combinations thereof.

Unless defined otherwise, all terms used herein, including technical or scientific terms, include the same meaning as commonly understood by one of ordinary skill in the art to which the present disclosure belongs. Terms such as those defined in commonly used dictionaries should be interpreted as including a meaning consistent with the meaning in the context of the related art, and unless explicitly defined in the present application, they should not be interpreted in an ideal or excessively formal meaning.

In the present disclosure, ‘˜ part’ may be implemented in various manners, for example, a processor, program instructions executed by the processor, software module, microcode, computer program product, logic circuit, application-specific integrated circuit, firmware, of the like, or may be implemented by hardware.

Hereinafter, with reference to the accompanying drawings, exemplary embodiments of the present disclosure will be described in more detail.

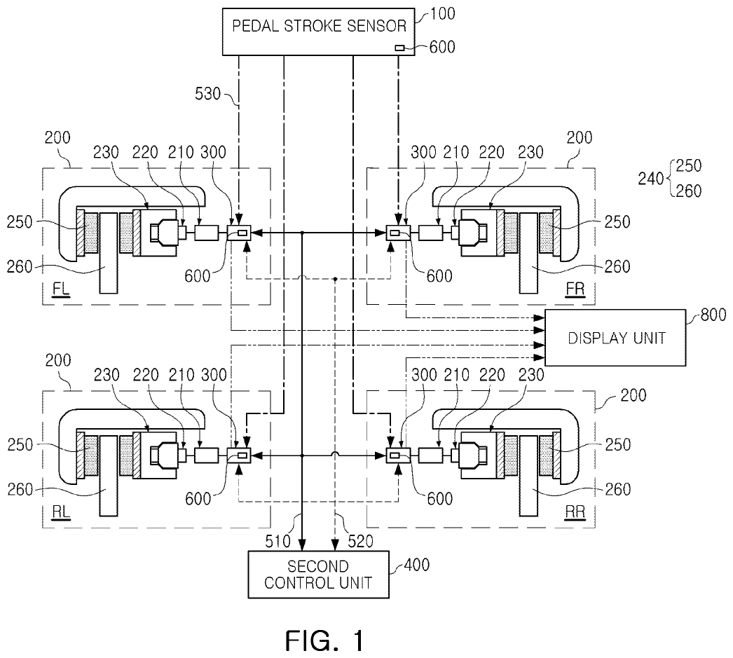

FIG. 1 is a conceptual diagram of an emergency braking apparatus according to an exemplary embodiment of the present disclosure.

Referring to FIG. 1, an emergency braking apparatus according to an exemplary embodiment of the present disclosure may include a pedal stroke sensor 100, a first controller 300, and a second controller 400.

The pedal stroke sensor 100 can detect pedal stroke information.

For example, the pedal stroke sensor 100 may be provided on a brake pedal, and confirm an opening amount of the brake pedal.

Here, the opening amount of the brake pedal may mean a degree to which a driver presses (or a degree to which a driver presses) the brake pedal. The opening amount of the brake pedal may be determined between 0% to 100%.

The braking device 200 may be a device generating braking force to slow down a vehicle or stop the vehicle.

The braking device 200 may be mounted on an individual wheel provided in a vehicle to generate braking force.

For example, the braking device 200 may be a hydraulic wheel brake operating through hydraulic pressure, or an electro-electronic wheel brake (e.g., electro-mechanical brake (EMB)) operating using electrical energy.

Hereinafter, a case in which the braking device 200 is an electromechanical braking (EMB) device 200 will be referred to as an exemplary embodiment of the present disclosure, but the present disclosure is not limited thereto.

Referring to FIG. 1, the braking device 200 may be provided on each wheel mounted on a vehicle.

The braking device 200 may include a driving unit 210, a power transmission unit 220, a power conversion unit 230, a braking force generating unit 240, and a first controller 300.

The driving unit 210 may provide a driving force that can generate braking force in the braking force generating unit 240. The driving unit 210 may be an actuator receiving electricity to generate driving force. The driving unit 210 may be configured to generate driving force through rotation generated by the actuator. For example, the actuator can be an electric motor (e.g., DC motor, stepper motor, brushless DC motor, servo motor, linear actuator, etc.).

The power transmission unit 220 may receive driving force generated by the rotation of the driving unit 210. The power transmission unit 220 may include a spindle, and may be connected to the driving unit 210 to receive rotational energy of the driving unit 210.

The power conversion unit 230 may convert the driving force of the rotation transmitted by the power transmission unit 220 into linear movement.

For example, the power conversion unit 230 may be a ball screw. When the driving force of the rotation received from the power transmission unit 220 rotates the screw, the ball can move linearly along the screw.

Alternatively, the power conversion unit 230 may include a bolt which rotates integrally with the spindle, a nut which moves forwards and backwards according to the rotation of the bolt, and a piston which includes the nut therein and moves together with the nut.

One end portion of the power conversion unit 230 may be connected to the power transmission unit 220 transmitting the driving force for rotational movement, and the other end portion of the power conversion unit 230 may be connected to the braking force generating unit 240.

The braking force generating unit 240 may be connected to the power converter 230 and move linearly, and may press a brake disc 260 to generate braking force.

For example, the braking force generating unit 240 may include at least one brake pad 250. Furthermore, the braking force generating unit 240 may be two brake pads 250 disposed to oppose each other with the brake disc 260 interposed therebetween.

The braking force generating unit 240 may be configured to generate braking force using frictional force generated when the two brake pads 250 disposed to oppose each other press the brake disk 260 in both directions.

In other words, the driving unit 210 may be configured to generate rotation energy based on the first controller 300, and the power transmission unit 220 may receive the rotation energy of the driving unit 210 and transmit the same to be delivered to the power conversion unit 230.

The power conversion unit 230 may convert the rotation energy of the driving unit 210 received from the power transmission unit 220 into linear movement energy. The braking force generating unit 240 may be moved by the converted linear movement energy, and press the brake disc 260, generating braking force.

The first controller 300 may be configured for controlling the driving unit 210 to adjust an amount of braking force in the braking device 200.

The second controller 400 may be connected to the pedal stroke sensor 100, and may be configured to determine braking information based on other driving information including stroke information received from the pedal stroke sensor 100.

Here, the braking information may be information for determining the magnitude of the braking force. For example, the braking information may be the braking force determined according to the size of the pedal stroke operated by the driver, the operating time of the driving unit 210 to generate the braking force, or pressure information between the brake pad 250 and the brake disc 260.

The second controller 400 may transmit the determined braking information to the first controller 300.

Here, the second controller 400 may be connected to the first controller 300 by wire. In particular, for duplication, the second controller 400 may be connected to the first controller 300 by a first wire 510 and a second wire 520.

For example, the first wire 510 and the second wire 520 may be one of Ethernet, Media Oriented Systems Transport (MOST), Flexray, Controller Area Network (CAN), Local Interconnect Network (LIN).

The first controller 300 may be wirelessly connected 530 to the pedal stroke sensor 100 and receive pedal stroke information.

For example, the first controller 300 may be wirelessly connected 530 using one communication means of Internet, LTE, 5G, Wi-Fi, Bluetooth, Near Field Communication (NFC), Zigbee, and Radio Frequency (RF) among the pedal stroke sensors 100.

The first controller 300 may be configured for controlling the braking device 200 based on pedal stroke information received wirelessly 530.

In the emergency braking apparatus according to various exemplary embodiments of the present disclosure, when the first controller 300 may receive braking information determined by the second controller 400 by the first wire 510 and the second wire 520, the first controller 300 may be configured for controlling the braking device 200 based on the braking information received from the second controller 400.

Here, the second controller 400 may transmit braking information based on braking force to be generated by an individual first controller 300 to the first controller 300, based on driving information including pedal stroke information.

Meanwhile, the first wire 510 and the second wire 520 may be damaged by external shocks, damaged by electric shocks, or an error may occur due to a circuit defect.

In the emergency braking apparatus according to an exemplary embodiment of the present disclosure, when an error has occurred in one of the first wire 510 and the second wire 520, the first controller 300 may be connected wirelessly 530 to the pedal stroke sensor 100, and may receive pedal stroke information.

Even when pedal stroke information has been received wirelessly 530, the first controller 300 may be configured for controlling the braking device 200 based on the braking information received using the other one of the first wire 410 and the second wire 520, in which an error does not occur.

Here, when an error has occurred in one of the first wire 510 and the second wire 520, the first controller 300 may more stably generate braking force using the braking device 200, using the stroke information received wirelessly 530.

For example, when a difference between the pedal stroke information received by wire and the pedal stroke information received wirelessly 530 exceeds a preset value, the first controller 300 may be configured for controlling the braking device 200 based on larger stroke information for safety, or control the braking device 200 by giving priority to one of wired or wireless stroke information 530.

That is, when an error has occurred in one of the first wire 510 and the second wire 520, the first controller 300 may compare the pedal stroke information received by wire and the pedal stroke information with the pedal stroke information received wirelessly 530 and select or adjust the pedal stroke information to enable the vehicle to be driven as stably as possible.

When an error has occurred in the first wire 510 and the second wire 520, the first controller 300 may transmit the braking device 200 to generate braking force in proportion to the size of the pedal stroke received wirelessly 530.

Furthermore, the second controller 400 may confirm whether the first controller 300 in which a problem has occurred in the first wire 510 or the second wire 520.

When it is confirmed that there is at least one first controller 300 in which an error has occurred in the first wire 510 and the second wire 520, the second controller 400 may stop controlling such as regenerative braking or adjusting braking force of front and rear wheels to control the vehicle's posture.

The first controller 300 in which a problem has occurred in the first wire 510 or the second wire 520 may be configured to generate braking force based on the pedal stroke information, adversely affecting driving stability of the vehicle due to a difference in braking force generated from the other normally operating first controller 300.

Therefore, when there is at least one first controller 300 in which a problem has occurred in the first wire 510 or the second wire 520, the second controller 400 may be configured for controlling the first controller 300, which is normally connected by wire, to generate a simple type of braking force for braking stability of the entire vehicle.

The emergency braking apparatus according to an exemplary embodiment of the present disclosure may further include a display unit 800.

The display unit 800 may notify that an error has occurred in a wire connecting the first controller 300 and the second controller 400.

The display unit 800 may visually or audibly notify a driver that an error has occurred in the wire connecting the first controller 300 and the second controller 400.

The display unit 800 may be a display configured for touch recognition (e.g., Audio, Video, Navigation (AVN)), an instrument panel, or the like, included in a cluster of a vehicle, or may be an audio system provided in the vehicle.

For example, the display unit 800 may display on a display included in the cluster of the vehicle that an error has occurred in the wire connecting the first controller 300 and the second controller 400. Furthermore, a problem has occurred with the vehicle's braking system may be displayed using a vehicle's audio (e.g., “Emergency braking is being performed. Please stop by your nearest repair shop for inspection,” or the like).

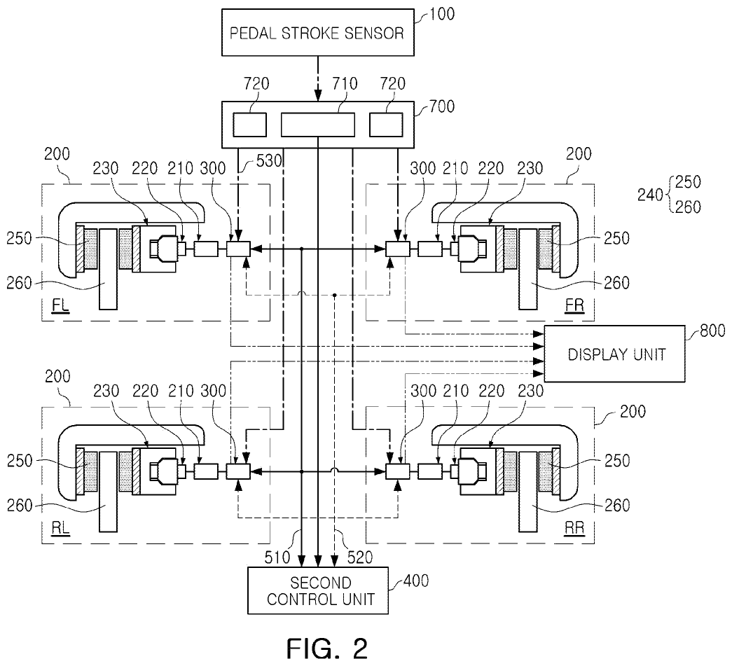

FIG. 2 is a conceptual diagram of an emergency braking apparatus according to another exemplary embodiment of the present disclosure.

An emergency braking apparatus according to another exemplary embodiment of the present disclosure may include a pedal stroke sensor 100, a first controller 300, a second controller 400, and a tire pressure monitoring system 700 (TPMS).

In relation to the emergency braking apparatus according to another exemplary embodiment of the present disclosure, the pedal stroke sensor 100, the first controller 300, and the second controller 400 include the same structure as the configuration described above with reference to FIG. 1, repeated detailed explanations are replaced with the above-described contents, and the differences are explained.

A tire pressure monitoring system (TPMS) of an emergency braking apparatus according to another exemplary embodiment of the present disclosure may include a low frequency initiator (LFI) and a first receiver 710.

In the tire pressure monitoring system (TPMS) 700, a communication process between a first receiver 710 provided on a vehicle body and a monitoring sensor provided on each wheel to detect tire conditions such as pressure and temperature will be described.

The first receiver 710 may be connected to the pedal stroke sensor 100, and may receive pedal stroke information, or transmit a wake-up signal to a monitoring sensor.

The first receiver 710 may transmit a wake-up signal, which is a digital signal, to a low frequency initiator (LFI) 720.

The low frequency initiator (LFI) 720 may modulate the wake-up signal and transmit the same to the monitoring sensor by a radio frequency (RF) signal.

The low frequency initiator (LFI) 720 may be modulated using methods such as Amplitude Shift Keying (ASK), Frequency Shift Keying (FSK), Phase Shift Keying (PSK), Quadrature Amplitude Modulation (QAM), Amplitude Modulation (AM), Phase Modulation (PM), Frequency Modulation (FM), Code Division Multiple Access (CDMA), Time Division Multiple Access (TDMA), and the like.

A second receiver of the monitoring sensor may decode a wake-up signal, which is a radio frequency (RF) signal.

The monitoring sensor may be activated based on a wake-up signal and may collect information regarding a current state of the tire, such as air pressure, temperature, and the like.

The monitoring sensor may transmit information regarding a current state of the tire collected using a transmitter to a first receiver 710, and the first receiver 710 may receive information regarding the current state of the tire.

Hereinafter, a process by which the first controller 300 receives pedal stroke information using the tire air pressure monitoring system 700 will be described.

The first receiver 710 may encrypt the received pedal stroke information and transmit the same to a low frequency initiator (LFI) 720.

The low frequency initiator (LFI) 720 may modulate the encrypted pedal stroke information and transmit the same by a radio frequency (RF) signal.

The low frequency initiator (LFI) 720 may be modulated using methods such as ASK (Amplitude Shift Keying), FSK (Frequency Shift Keying), PSK (Phase Shift Keying), QAM (Quadrature Amplitude Modulation), AM (Amplitude Modulation), PM (Phase Modulation), FM (Frequency Modulation), Code Division Multiple Access (CDMA), Time Division Multiple Access (TDMA), and the like.

The first controller 300 may further include a radio frequency receiver, and the radio frequency receiver may decode the received pedal stroke information.

The first controller 300 may be configured for controlling the braking device 200 using pedal stroke information to generate braking force.

An emergency braking apparatus according to another exemplary embodiment of the present disclosure may further include a display unit 800.

The display unit 800 may display externally that the tire air pressure monitoring system 700 cannot be used, and may notify that an error has occurred in a wire connecting the first controller 300 and the second controller 400.

The display unit 800 may display externally that the tire pressure monitoring system 700 cannot be used, and may visually or audibly notify a driver that an error has occurred in the wire connecting the first controller 300 and the second controller 400.

The display unit 800 may be a display configured for touch recognition (e.g., Audio, Video, Navigation (AVN)), an instrument panel, or the like, included in a cluster of a vehicle, or may be an audio system provided in the vehicle.

For example, the display unit 800 may display a tire pressure monitoring system failure warning light on a display included in the cluster of the vehicle. Furthermore, a problem has occurred with the vehicle's braking system may be indicated using a vehicle's audio system (e.g., “currently, a braking signal has been received using the tire pressure monitoring system 700”, Please stop by your nearest repair shop for inspection,” or the like).

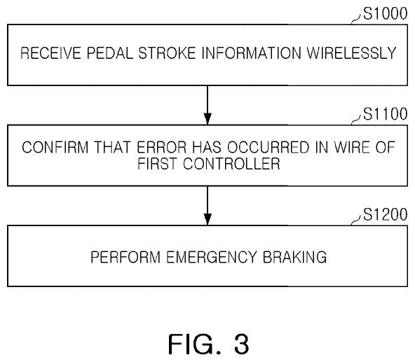

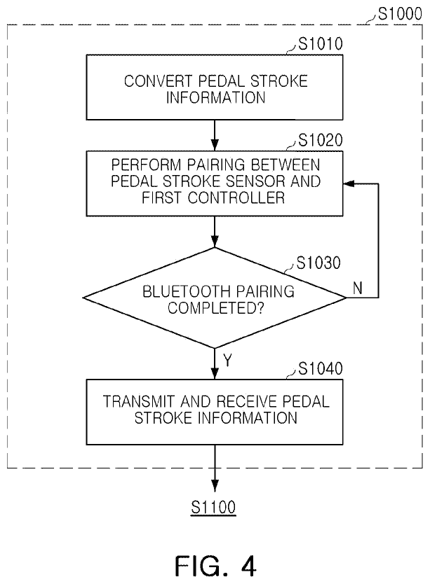

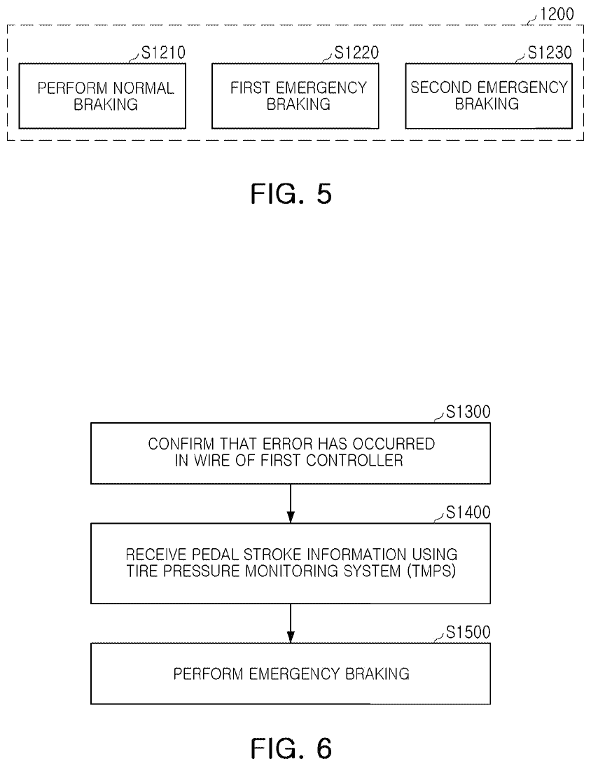

FIG. 3 is a flowchart of an emergency braking method according to an exemplary embodiment of the present disclosure, FIG. 4 is a detailed flowchart of S1000 according to an exemplary embodiment of the present disclosure, and FIG. 5 is a detailed flowchart of S1300 according to an exemplary embodiment of the present disclosure.

Referring to FIG. 3, the first controller 300 may receive pedal stroke information wirelessly 530 (S1000).

Referring to FIG. 4, the emergency braking method according to an exemplary embodiment of the present disclosure may receive pedal stroke information using Bluetooth.

The first controller 300 and the pedal stroke sensor 100 may each be provided with a Bluetooth module 600, and the first controller 300 may receive pedal stroke information from the pedal stroke sensor 100 using Bluetooth.

The pedal stroke sensor 100 may convert pedal stroke information into a digital signal (S1010).

Here, when a sensor signal is an analog signal, the pedal stroke sensor 100 may convert the analog signal into a digital signal, and when the sensor signal is a digital signal, the pedal stroke sensor 100 may be omitted.

The first controller 300 and a Bluetooth module 600 of the pedal stroke sensor 100 may perform pairing with each other (S1020).

Here, pairing may be a process for two Bluetooth devices to recognize and be connected to each other. Two Bluetooth devices may recognize each other's presence, exchange and confirm each other's information, and be connected to each other. Furthermore, the two Bluetooth devices may store each other's unique Bluetooth address, and from then on, the two Bluetooth devices can automatically recognize each other's presence and be connected.

The first controller 300 and the Bluetooth module 600 of the pedal stroke sensor 100 may attempt pairing until pairing is completed (S1030).

When pairing is completed between the pedal stroke sensor 100 and the first controller 300, the pedal stroke sensor 100 may transmit pedal stroke information to the first controller 300 using Bluetooth (S1040).

A process of transmitting and receiving information using Bluetooth may be performed using a general process of Bluetooth communication included before the present disclosure.

Referring again to FIG. 3, in the emergency braking method according to an exemplary embodiment of the present disclosure, the first controller 300 may confirm whether there is an error in a wired connection between the first controller 300 and the second controller 400 (S1100) has occurred.

Here, the wired connection between the first controller 300 and the second controller 400 may be dual, and may include a first wire 510 and a second wire 520.

The second controller 400 may transmit a normal operation signal together with braking information using the first wire 510 and the second wire 520, and the first controller 300 may receive a normal operation signal and confirm whether the first wire 510 and the second wire 520 are abnormal.

When a problem has occurred in the first wire 510, the second wire 520, or the second controller 400, the first controller 300 may not receive a normal operation signal from the first wire 510 or the second wire 520, or from the first wire 510 and the second wire 520.

When it is confirmed that an error has occurred in the wired connection, the first controller 300 can confirm whether an error has occurred in the first wire 510 and the second wire 520.

Furthermore, the second controller 400 may confirm a first controller 300 of the plurality of first controllers 300, in which an error has occurred. The second controller 400 may confirm the first controller 300 in which an error has occurred, and may confirm whether an error has occurred in one of the first wire 510 or the second wire 520, or whether an error has occurred in both the first wire 510 and the second wire 520.

According to the results of confirming whether an error occurred in the wires of the first controller 300, emergency braking may be performed (S1200).

Referring to FIG. 5, when the first wire 510 and the second wire 520 operate normally, the first controller 300 may be configured for controlling the braking device 200 based on braking information received from the second controller 400 using the first wire 510 and the second wire 520 to generate braking force (S1210).

When an error has occurred in one of the first wire 510 and the second wire 520, the emergency braking method according to an exemplary embodiment of the present disclosure may perform first emergency braking (S1220).

Here, the first emergency braking may be performed based on braking information received through one of the normally operating first wire 510 and the second wire 520, and the first controller 300 may be configured for controlling the braking device 200.

Furthermore, when an error has occurred in one of the first wire 510 and the second wire 520, the first emergency braking may be performed using stroke information received wirelessly 530, and may be performed more conservatively using the braking device 200 for safety reasons, to generate braking force.

For example, when a difference between the pedal stroke information received by wire from one of the first wire 510 and the second wire 520, which operate normally and the pedal stroke information received wirelessly 530 exceeds a preset value, the first controller 300 may be configured for controlling the braking device 200 based on larger stroke information for safety, or control the braking device 200 by giving priority to one of the wired and wireless stroke information 530.

When an error has occurred in the first wire 510 and the second wire 520, the emergency braking method according to an exemplary embodiment of the present disclosure may perform second emergency braking (S1400).

In the second emergency braking, the first controller 300 may be configured for controlling the braking device 200 based on braking information received using the other one of the first wire 510 and the second wire 520 in which an error does not occur.

In the second emergency braking, the second controller 400 may stop controlling such as regenerative braking or adjusting the braking force of front and rear wheels to control the vehicle's posture.

Furthermore, the second controller 400 may be configured for controlling the first controller 300, which is normally connected by wire, to generate a simple type of braking force for braking stability of the entire vehicle.

For example, the second controller 400 may also transmit braking information proportional to the pedal stroke to the first controller 300, which is normally connected by wire.

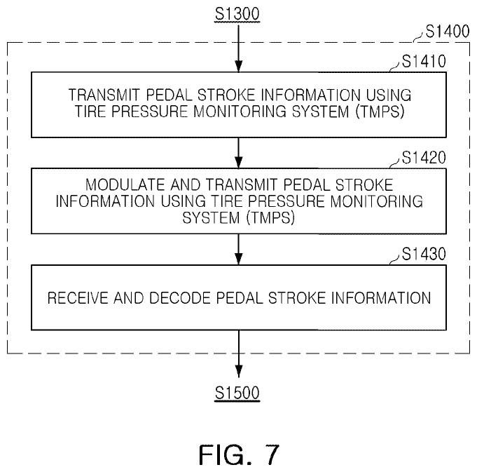

FIG. 6 is a flowchart of an emergency braking method according to another exemplary embodiment of the present disclosure, and FIG. 7 is a detailed flowchart of S1400 according to another exemplary embodiment of the present disclosure.

In relation to the emergency braking method according to another exemplary embodiment of the present disclosure, the same contents as the configuration described above with reference to FIG. 3, FIG. 4, and FIG. 5 will be replaced with the above-described contents, and differences thereof will be described.

Referring to FIG. 6, in the emergency braking method according to an exemplary embodiment of the present disclosure, whether an error has occurred in a wired connection between a first controller 300 and a second controller 400 may be confirmed by the first controller 300 (S1300).

Here, the wired connection between the first controller 300 and the second controller 400 may be dual, and may include a first wire 510 and a second wire 520.

A tire pressure monitoring system (TPMS) 700 is used to monitor a condition of tires and is configured to perform a role of transmitting and receiving tire information, so that the tire pressure monitoring system (TPMS) may not perform the original role when used in the emergency braking method according to another exemplary embodiment of the present disclosure.

Therefore, unlike the case of using a Bluetooth device according to an exemplary embodiment of the present disclosure, an error in a wired connection may be first confirmed, and when it is confirmed that an error has occurred in the wired connection, pedal stroke information may be received using the tire pressure monitoring system (TPMS) 700.

Meanwhile, when pedal stroke information has been received using a tire air pressure monitoring system 700 (TPMS), the tire pressure monitoring system 700 (TPMS) may notify that tire condition information cannot be transmitted or received.

For example, when pedal stroke information has been received using a tire pressure monitoring system 700 (TPMS), the tire pressure monitoring system (TPMS) failure warning light provided on an instrument panel of a vehicle may be turned on.

Alternatively, the above-described display unit 800 may be used to display that tire condition information may not be transmitted or received using the tire pressure monitoring system 700 (TPMS).

When an error has occurred in a wired connection between the first controller 300 and the second controller 400 is confirmed, pedal stroke information may be received using the tire air pressure monitoring system (TPMS) 700 (S1400).

Referring to FIG. 7, a pedal stroke sensor 100 may convert pedal stroke information into a digital signal and transmit the same to the tire pressure monitoring system 700 (S1410).

Here, when a sensor signal is an analog signal, the pedal stroke sensor 100 may convert the analog signal into a digital signal, and when the sensor signal is a digital signal, a process of converting the sensor signal into a digital signal may be omitted.

The tire air pressure monitoring system 700 may receive pedal stroke information received from the first pedal stroke sensor 100 using a first receiver 710.

The first receiver 710 may encrypt the received pedal stroke information and transmit the same to a low frequency initiator (LFI) 720.

Here, the low frequency initiator (LFI) 720 may modulate the encrypted pedal stroke information into a radio frequency (RF) signal and transmit the same to a first controller 300 (S1420).

The low frequency initiator (LFI) 720 may modulate pedal stroke information into a radio frequency (RF) signal using methods such as ASK (Amplitude Shift Keying), FSK (Frequency Shift Keying), PSK (Phase Shift Keying), QAM (Quadrature Amplitude Modulation), AM (Amplitude Modulation), PM (Phase Modulation), FM (Frequency Modulation), Code Division Multiple Access (CDMA), Time Division Multiple Access (TDMA), and the like.

The first controller 300 may further include a radio frequency receiver, and the radio frequency receiver may decode the received pedal stroke information (S1430).

According to a result that an error has occurred in the wired connection of the first controller 300, emergency braking may be performed (S1200).

In the emergency braking apparatus and emergency braking method, even when a problem has occurred in a wired line transmitting braking commands from a main controller, by receiving pedal stroke information wirelessly 530 from a controller provided in the braking device 200 to generate braking force, vehicle stability may be improved.

Furthermore, in the emergency braking apparatus and emergency braking method, even when a problem has occurred in the main controller, a controller provided at each wheel may be configured to generate braking force to an individual braking device 200 according to information from the pedal stroke sensor 100 connected wirelessly 530.

The methods according to an exemplary embodiment of the present disclosure may be implemented in a form of program instructions which may be executed by various computer means and recorded on a computer readable medium. The computer readable medium may include program instructions, data files, data structures, or the like, alone or in combination thereof. Program instructions recorded on a computer readable medium may be specially designed and configured for an exemplary embodiment of the present disclosure, or may be known and usable to those skilled in the art of computer software.

Examples of computer readable media include hardware devices specially configured to store and execute program instructions, such as ROM, RAM, flash memory, and the like. Examples of program instructions include high-level language codes which may be executed by a computer using an interpreter, or the like as well as machine language codes such as those produced by a compiler. The hardware device described above may be configured to operate with at least one software module to perform the operations of the present disclosure, and vice versa.

As set forth above, according to an exemplary embodiment of the present disclosure, even when a problem has occurred in a wired connection for transmitting braking information, vehicle braking stability may be improved by receiving pedal stroke information wirelessly to generate braking force.

The aforementioned description merely illustrates the technical concept of the present disclosure, and a person skilled in the art to which an exemplary embodiment of the present disclosure pertains may make various modifications and modifications without departing from the essential characteristics of the present disclosure.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An emergency braking apparatus, comprising:
a first controller controlling a braking device;
a pedal stroke sensor receiving pedal stroke information of a brake pedal; and
a second controller connected to the first controller by a wire to control the first controller, based on the pedal stroke information,
wherein the first controller is wirelessly connected to the pedal stroke sensor and receives the pedal stroke information to control the braking device.

2. The emergency braking apparatus of claim 1,
wherein the wire includes a first wire and a second wire, and
wherein the first controller and the second controller are dually connected by the first wire and the second wire, and
wherein the second controller is configured to control the first controller using one of the first wire and the second wire.

3. The emergency braking apparatus of claim 2, wherein in response that an error has occurred in at least one of the first wire and the second wire,
the first controller is wirelessly connected to the pedal stroke sensor and receives the pedal stroke information.

4. The emergency braking apparatus of claim 1, wherein the first controller is configured to receive the pedal stroke information using Bluetooth.

5. The emergency braking apparatus of claim 1, wherein the first controller is configured to receive the pedal stroke information using a tire pressure monitoring system (TPMS) provided with a low frequency initiator (LFI).

6. The emergency braking apparatus of claim 5, further including:
a display unit displaying that the first controller receives the pedal stroke information using a tire pressure monitoring system.

7. The emergency braking apparatus of claim 5, wherein the first controller is configured to receive the pedal stroke information modulated from the tire pressure monitoring system by a radio frequency (RF) signal.

8. The emergency braking apparatus of claim 7, wherein the first controller is configured to control the braking device by decoding the pedal stroke information.

9. The emergency braking apparatus of claim 7, wherein a radio frequency for transmitting the pedal stroke information is set differently from a radio frequency for transmitting wake up information of the tire pressure monitoring system.

10. The emergency braking apparatus of claim 1, wherein the first controller is configured to control the braking device to generate braking force in proportion to a size of a pedal stroke of the brake pedal.

11. An emergency braking method, comprising:
receiving, by a first controller, braking information from a second controller connected to the first controller in a wired connection by a wire; and
controlling, by the first controller, a braking device based on the braking information,
wherein in response that an error has occurred in the wired connection, the receiving of the braking information from the second controller connected to the first controller by the wire includes:
receiving, by the first controller, pedal stroke information of a brake pedal using a wireless connection; and
controlling, by the first controller, the braking device, based on one of the pedal stroke information or the braking information.

12. The emergency braking method of claim 11,
wherein the wire includes a first wire and a second wire,
wherein the first controller and the second controller are dually connected by the first wire and the second wire, and
in confirming the braking information of the second controller connected to the first controller by the wire,
the first controller confirms the braking information of the second controller using one of the first wire and the second wire.

13. The emergency braking method of claim 12, wherein in response that an error has occurred in one of the first wire and the second wire,
in the controlling, by the first controller, of the braking device, the braking device is controlled based on the braking information.

14. The emergency braking method of claim 12, wherein in response that an error has occurred in one of the first wire and the second wire,
in the controlling, by the first controller, the braking device, the braking device is controlled based on the pedal stroke information.

15. The emergency braking method of claim 11, wherein in the receiving, by the first controller, of the pedal stroke information using the wireless connection, the pedal stroke information has been received using Bluetooth.

16. The emergency braking method of claim 11, wherein in the receiving, by the first controller, of the pedal stroke information using the wireless connection,
the pedal stroke information has been received using a tire pressure monitoring system (TPMS) provided with a low frequency initiator (LFI).

17. The emergency braking method of claim 16, wherein the receiving, by the first controller, the pedal stroke information using the wireless connection further includes,
receiving the pedal stroke information modulated and transmitted by a pedal stroke sensor; and
demodulating the received pedal stroke information.

18. The emergency braking method of claim 16, wherein in response that the pedal stroke information has been received using the tire pressure monitoring system (TPMS), the emergency braking method further includes:
displaying that tire pressure monitoring information is not received.

19. The emergency braking method of claim 11, wherein in the controlling, by the first controller, of the braking device,
the braking device is controlled to generate a braking force in proportion to a size of a pedal stroke in the brake pedal.
